(19) United States
(12) Patent Application Publication
(10) Pub. No.: US 2005/0116640 A1
(43) Pub. Date: Jun. 2, 2005

(54) Plasma display panel

(76) Inventor: Sung-Hune Yoo, Asan-si (KR)

Correspondence Address: Robert E. Bushnell;Suite 300, 1522 K. Street, N.W., Washington, DC, 20005-1202, US

(21) Appl. No.: 10/965,291

(22) Filed: Oct. 15, 2004

(30) Foreign Application Priority Data
Oct. 16, 2003 (KR) 2003-72156

(51) Int. Cl. H01J 11/02; H01J 17/49

(52) U.S. Cl. 313/582

(57) ABSTRACT

A plasma display panel includes: a front substrate; a sustain electrode arranged on the front substrate; a front dielectric layer covering the sustain electrode; a rear substrate facing the front substrate; an address electrode arranged on the rear substrate; a rear dielectric layer covering the address electrode and having a crystallized structure; barrier ribs disposed between the front and rear substrates; and colored phosphor layers arranged in a discharge space defined by the barrier ribs. The dielectric layer arranged on the substrate is opaque to prevent light from exiting out of the rear surface of the panel, thereby improving a light emitting efficiency of the panel.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on Oct. 16, 2003 and there duly assigned Serial No. 2003-72156.

### BACKGROUND OF THE INVENTION

1. Field of the Invention

The present invention relates to a Plasma Display Panel (PDP), and more particularly, to a plasma display panel that has a crystallized dielectric layer arranged on a substrate thereof to prevent a degradation in brightness.

2. Description of the Related Art

In general, a plasma display panel is a flat panel display device that realizes desired numbers, characters, or graphics by injecting and sealing a discharge gas between two substrates on which a plurality of discharge electrodes are formed, applying a discharging voltage between the substrates, and applying an appropriate pulse voltage to the substrates to address a point where two electrodes cross each other such that the gas between the substrates emits light due to the discharge voltage.

A plasma display panel includes a front substrate, a plurality of sustain electrodes formed on an inner surface of the front substrate, a front dielectric layer covering the sustain electrodes, a protecting layer formed on an inner surface of the front dielectric layer, a rear substrate facing the front substrate, a plurality of address electrodes formed on an inner surface of the rear substrate, a rear dielectric layer covering the address electrodes, barrier ribs arranged between the front and rear substrates to divide a discharge space, and colored phosphor layers, e.g.—red, green, and blue phosphor layers, coated on an inner side of the barrier ribs. A discharge area is formed on an inner portion of coupled front and rear substrates by injecting an inert gas therein.

The rear dielectric layer is formed by baking a glass powder. The rear dielectric layer has a high transmittance since it is an amorphous layer. In order to increase a reflectivity of the rear dielectric layer, a filler, such as TiO₂, is added in a dielectric paste. Accordingly, a whiteness of the rear dielectric layer rises, and the reflectivity can be improved.

However, when the content of TiO₂ is increased, a resistance of the dielectric layer is lowered because Ti is a conductive material.

Also, since a dispersion of Ti is lowered, Ti can be locally concentrated and exist as large particles, and a withstanding voltage is reduced. Accordingly, the rear dielectric layer can be damaged.

### SUMMARY OF THE INVENTION

The present invention provides a plasma display panel, which can increase a light emitting efficiency by adding a nucleator to a dielectric layer formed on a substrate to cause the dielectric layer to have a crystalline structure.

According to an aspect of the present invention, a Plasma Display Panel (PDP) is provided comprising: a front substrate; a sustain electrode arranged on the front substrate; a front dielectric layer covering the sustain electrode; a rear substrate facing the front substrate; an address electrode arranged on the rear substrate; a rear dielectric layer covering the address electrode, and having a crystallized structure; barrier ribs disposed between the front and rear substrates; and colored phosphor layers arranged in a discharge space defined by the barrier ribs.

The rear dielectric layer preferably comprises a Li₂O—Al₂O₃—SiO₂ based layer.

The rear dielectric layer preferably comprises SiO₂ of 5-75 wt %, Al₂O₃ of 14-30 wt %, and Li₂O of 1.5-3 wt %.

The rear dielectric layer preferably comprises at least one nucleator selected from the group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂O₅ of 0-8 wt %.

The rear dielectric layer preferably further comprises an alkaline earth metal.

The alkaline earth metal is preferably within a range of 3-18 wt %.

The rear dielectric layer preferably comprises a PbO—ZnO—Al₂O₃ based layer.

The rear dielectric layer preferably comprises ZnO of 45 wt % or more, and Al₂O₃ of 14 wt % or more.

The rear dielectric layer preferably comprises at least one nucleator selected from the group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂o₅ of 0-8 wt %.

The rear dielectric layer preferably further comprises an alkaline earth metal.

The alkaline earth metal is preferably within a range of 3-18 wt %.

The rear dielectric layer preferably comprises crystals having sizes in a range of 0.05-1.5 μm.

The rear dielectric layer is preferably opaque to prevent emitted light from being transmitted therethrough.

According to another aspect of the present invention, a Plasma Display Panel (PDP) is provided comprising: a front substrate; a sustain electrode arranged on the front substrate; a rear substrate facing the front substrate; an address electrode arranged on the rear substrate; a dielectric layer covering at least one of the sustain electrode and the address electrode, and including a nucleator to diffusely reflect emitted light; barrier ribs disposed between the front and rear substrates; and colored phosphor layers arranged in a discharge area defined by the barrier ribs.

The dielectric layer preferably comprises Li₂O—Al₂O₃—SiO₂.

The dielectric layer preferably comprises PbO—ZnO—Al₂O₃.

The nucleator preferably comprises at least one selected from the group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂O₅ of 0-8 wt %.

The dielectric layer preferably further comprises an alkaline earth metal within a range of 3-18 wt %.

The dielectric layer preferably comprises crystals having sizes in a range of 0.05-1.5 μm.

According to yet another aspect of the present invention, a Plasma Display Panel (PDP) is provided comprising: a front substrate; a rear substrate facing the front substrate; and a rear dielectric layer arranged on the rear substrate and having a crystallized structure.

The rear dielectric layer preferably comprises a Li₂O—Al₂O₃—SiO₂ based layer.

The rear dielectric layer preferably comprises SiO₂ of 5-75 wt %, Al₂O₃ of 14-30 wt %, and Li₂O of 1.5-3 wt %.

The rear dielectric layer preferably comprises at least one nucleator selected from the group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂₀₃ of 0-7 wt %, Na₂O of 0-4 wt %, and P₂O₅ of 0-8 wt %.

The rear dielectric layer preferably further comprises an alkaline earth metal.

The alkaline earth metal is preferably within a range of 3-18 wt %.

The rear dielectric layer preferably comprises a PbO—ZnO—Al₂O₃ based layer.

The rear dielectric layer preferably comprises ZnO of 45 wt % or more, and Al₂O₃ of 14 wt % or more.

The rear dielectric layer preferably comprises at least one nucleator selected from the group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂O₅ of 0-8 wt %.

The rear dielectric layer preferably further comprises an alkaline earth metal.

The alkaline earth metal is preferably within a range of 3-18 wt %.

The rear dielectric layer preferably comprises crystals having sizes in a range of 0.05-1.5 μm.

The rear dielectric layer is preferably opaque to prevent emitted light from being transmitted therethrough.

According to still another aspect of the present invention, a Plasma Display Panel (PDP) is provided comprising: a front substrate; a rear substrate facing the front substrate; and a dielectric layer arranged on the rear substrate and including a nucleator to diffusely reflect emitted light.

The dielectric layer preferably comprises Li₂O—Al₂O₃—SiO₂.

The dielectric layer preferably comprises PbO—ZnO—Al₂O₃.

The nucleator preferably comprises at least one selected from the group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂O₅ of 0-8 wt %.

The dielectric layer preferably further comprises an alkaline earth metal within a range of 3-18 wt %.

The dielectric layer preferably comprises crystals having sizes in a range of 0.05-1.5 μm.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a unit cell in a PDP; and

FIG. 2 is an exploded perspective view of a part of a PDP according to an embodiment of the present invention.

### DETAILED DESCRIPTION OF THE INVENTION

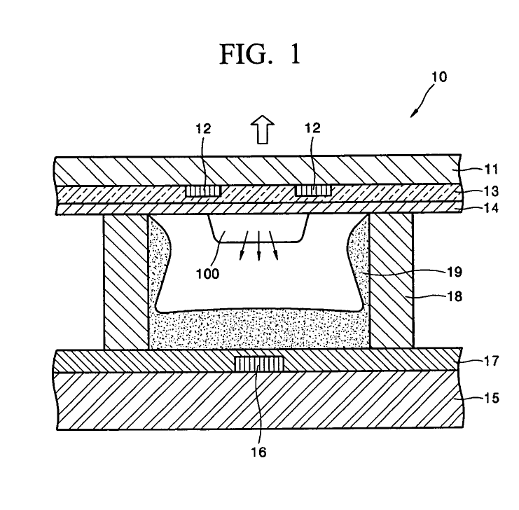

Referring to FIG. 1, a plasma display panel 10 includes a front substrate 11, a plurality of sustain electrodes 12 formed on an inner surface of the front substrate 11, a front dielectric layer 13 covering the sustain electrodes 12, a protecting layer 14 formed on an inner surface of the front dielectric layer 13, a rear substrate 15 facing the front substrate 1, a plurality of address electrodes 16 formed on an inner surface of the rear substrate 15, a rear dielectric layer 17 covering the address electrodes 16, barrier ribs 18 arranged between the front and rear substrates 11 and 15 to divide a discharge space, and colored phosphor layers 19 coated on an inner side of the barrier ribs 18. A discharge area is formed on an inner portion of coupled front and rear substrates 11 and 15 by injecting an inert gas therein.

The rear dielectric layer 17 is formed by baking a glass powder. The rear dielectric layer 17 has a high transmittance since it is an amorphous layer. In order to increase a reflectivity of the rear dielectric layer 17, a filler, such as TiO₂, is added in a dielectric paste. Accordingly, a whiteness of the rear dielectric layer rises, and the reflectivity can be improved.

However, when the content of TiO₂ is increased, a resistance of the dielectric layer 17 is lowered, as shown in Table 1, because Ti is a conductive material.

Also, since a dispersion of Ti is lowered, Ti can be locally concentrated and exist as large particles, and a withstanding voltage is reduced. Accordingly, the rear dielectric layer 17 can be damaged.

TABLE 1

| | | | TiO₂ |
|---|---|---|---|
| | TiO₂ 0 wt % | TiO₂ 3.1 wt % | 10 wt % |
| Minimum withstanding | 667 | 639 | 512 |
| voltage (V) | | | |
| Average of minimum | 676 | 639 | 530 |
| withstanding voltages (V) | | | |
| Entire withstanding | 782 | 703 | 635 |
| voltage (V) | | | |

The minimum withstanding voltage is the lowest withstanding value measured by checking various points on a panel, and the average of minimum withstanding voltages is an average of the three lowest withstanding voltages, and the entire withstanding voltage is an average of the withstanding voltages of all of the points.

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

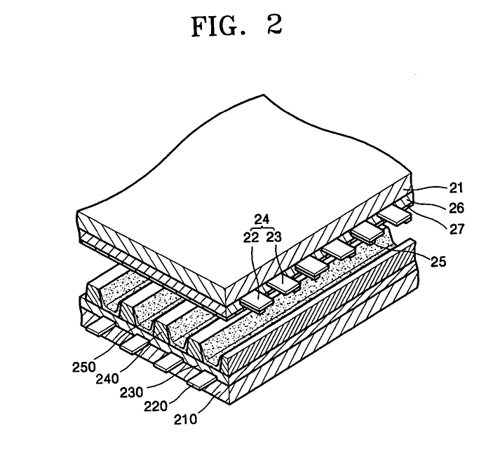

FIG. 2 is a view of a PDP 20 according to an exemplary embodiment of the present invention. Referring to FIG. 2, the PDP 20 includes a front substrate 21, and a rear substrate 210 facing the front substrate 21.

A plurality of sustain electrodes 24, each of which includes an X electrode 22 and a Y electrode 23 having a predetermined interval therebetween, are disposed on a lower surface of the front substrate 21. The sustain electrodes 24 are arranged in a striped pattern. Bus electrodes 25 are formed on lower surfaces of the X and Y electrodes 22 and 23 to reduce line resistances of the X and Y electrodes 22 and 23. The X and Y electrodes 22 and 23, and the bus electrodes 25 are covered by a front dielectric layer 26. A protecting layer 27, such as a magnesium oxide layer, is coated on a surface of the front dielectric layer 26.

A plurality of address electrodes 220 having predetermined intervals therebetween are formed on an upper surface of the rear substrate 210. The address electrodes 220 are arranged to cross the sustain electrodes 24. The address electrodes 220 are covered by a rear dielectric layer 230. Barrier ribs 240 are formed on an upper surface of the rear dielectric layer 230 to define a discharge space and to prevent cross-talk from occurring. Colored phosphor layers 250 are arranged on an inner wall of the barrier ribs 240 and the upper surface of the rear dielectric layer 230.

According to the present invention, the rear dielectric layer 230 is formed as an opaque crystalline layer by adding a small amount of a nucleator to a raw material of the dielectric layer to improve its light emitting efficiency.

The rear dielectric layer 230 is described in more detail as follows.

The rear dielectric layer 230 comprises a Li₂O—Al₂O₃—SiO₂ based glass. It is desirable that the Li₂O—Al₂O₃—SiO₂ based glass is in a predetermined range of wt % in consideration of a thermal processing temperature in the baking process. That is, the rear dielectric layer 230 contains 5-75 wt % SiO₂, 14-30 wt % Al₂O₃, and 1.5-3 wt % LiO₂.

In forming the Li₂O—Al₂O₃—SiO₂ based rear dielectric layer 230, a nucleator is included in a dielectric powder to cause crystallization during the thermal process. The nucleator is one of selected from a group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂O₅ of 0-8 wt %.

The formation of the Li₂O—Al₂O₃—SiO₂ based rear dielectric layer 230 including the above nucleator is described as follows.

When the Li₂O—Al₂O₃—SiO₂ based glass is thermally processed, a crystallized glass including a β-quartz crystalline solid solution (that is, silica including a small amount of Li or Al), and β-eucryptite (that is, Li₂O Al₂O₃ 2SiO₂) is obtained. The crystallized glass has a thermal expansion coefficient of 0 or a negative value. The crystallized glass hardly expands due to heat, and thus, is resistant to thermal shock.

The glass is maintained at a nuclear forming temperature for a long time to form more nuclei, and the crystal is grown to obtain a crystal having a size of 30-60 nanometers that is much smaller than a wavelength of visible light. In addition, a refractive index is similar to that of the rear substrate 210, and thus, the glass is nearly transparent in the visible light range.

When the crystallized glass is thermally processed at a higher temperature, the β-quartz crystalline solid solution is phase-changed to β-spodumene, and the size of the crystalline solution grows to about 1 μm.

Accordingly, the crystallized glass becomes opaque, and the thermal expansion rate is maintained. The crystallized glass can be manufactured to be transparent or opaque according to the thermal processing conditions. The grain size of the final crystalline solution in the crystallized glass is about 0.05-1.5 μm. When the grain size of the crystalline solution is 0.05 μm or smaller, crystallization does not occur, and the glass remains in the amorphous state. In addition, when the grain size of the crystalline solution is 1.5 μm or larger, the crystalline grains becomes large, thereby reducing a diffused reflection efficiency.

On the other hand, a small amount of residual glass phases fills out the volumes of grain boundaries to form a structure with no air pores. The finally crystallized glass has superior resistances to mechanical and thermal shocks. That is, the resistance of the crystallized glass to mechanical shock is improved by removing the air pores that concentrate the stress, and the resistance of the crystallized glass to thermal shock is improved by the low thermal expansion coefficient.

In the crystallized glass, the nuclei are formed on phase boundaries of impurities, and then, large crystals grow, and thus, the fine structure of the glass is rough, large, and irregular.

The nucleator, that is, at least one of selected from a group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂O₅ of 0-8 wt % is added to the crystallized glass, and thus, the injected particles of the nucleator have a high nuclear density of 10¹² per mm³ or more.

Moreover, it is desirable that an alkaline earth metal, that is, one selected from a group consisting of BaO, CaO, SrO, and Bi₂O₃ is added into the Li₂O—Al₂O₃—SiO₂ based glass in consideration of the baking process and a softening point of the glass. It is desirable for the alkaline earth metal to added within a range of 3-18 wt %.

Manufacturing processes of the plasma display panel 20 that includes the rear dielectric layer 230 having the opaque crystalline are described as follows.

The X electrode 22 and Y electrode 23 are patterned on the front substrate 21 formed of a transparent glass. It is desirable that the X and Y electrodes 22 and 23 are formed of an Indium-Tin-Oxide (ITO) transparent conductive layer. The bus electrode 25 comprises a silver paste formed on lower surfaces of the X and Y electrodes 22 and 23 in order to reduce their line resistance.

The front dielectric layer 26 is coated on the lower surface of the front substrate 21, where the X and Y electrodes 22 and 23 and the bus electrode 25 are formed. The front dielectric layer 26 can be formed by baking the material of the front substrate 21.

A protecting layer 27, formed of an oxide, such as MgO, is coated on the surface of the front dielectric layer 26.

The address electrodes 220 are patterned on the rear substrate 210, arranged to face the front substrate 21, to cross the sustain electrodes 24.

The rear dielectric layer 230 is coated on the rear substrate 210 to cover the address electrodes 220. The rear dielectric layer 230 is formed by patterning an Li₂O—Al₂O₃—SiO₂ based dielectric paste on the rear substrate 210 with a printing method, drying the patterned paste, and baking the dried paste at a temperature in the range of 550° C.-600° C.

In order to crystallize the layer during the thermal process, the Li₂O—Al₂O₃—SiO₂ based dielectric paste includes a nucleator, for example, one selected from a group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, Ba₂O₃ of 0-7 wt %, Na₂O of 0-4 wt %, and P₂O₅ of 0-8 wt %. In addition, an alkaline earth metal can be further added to the dielectric paste within a range of 3-18 wt % in consideration of the softening point of the glass.

The barrier ribs 240 are formed on an upper surface of the rear dielectric layer 230. The shape of the barrier ribs 240 is not limited to a strip shape, but can be a waffle type, or a meander type if it can define the discharge area.

Colored phosphor layers 250 are arranged on the discharge area defined by the barrier ribs 250. In the post process, in which the barrier ribs 240 and the phosphor layers 250 are formed, the substrates are baked at a temperature in the range of 480-550° C. to grow the crystals of the rear dielectric layer 230. Accordingly, the rear dielectric layer 230 has the crystalline structure having crystals of 0.05-1.5 μm sizes, and becomes opaque.

The front and rear substrates 21 and 210 manufactured by the above processes are sealed together, and exhausted to be in a vacuum state.

The rear dielectric layer 230 according to a second embodiment of the present invention is a PbO based layer.

Since the operations and manufacturing processes of the rear dielectric layer 230 are same as those of the above embodiment, the features of the present embodiment will only be described as follows.

When the rear dielectric layer 230 is based on PbO, it includes ZnO of 45 wt % or more and Al₂O₃ of 14 wt % or more. Also, the PbO based rear dielectric layer 230 further includes a nucleator, that is, at least one selected from a group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂O₅ of 0-8 wt %. Moreover, an alkaline earth metal within a range of 3-18 wt % can be further added to the rear dielectric layer 230.

According to an experiment implemented by the present applicant, when the above described nucleator was added to the material of the rear dielectric layer 230, a withstanding voltage of the layer was 700V or more, which is higher than when TiO₂ is added to the rear dielectric layer.

As described above, in a PDP according to the embodiments of the present invention, the dielectric layer formed on the substrate is opaque so as to prevent light from exiting out of the rear surface of the panel, thereby improving the light emitting efficiency of the panel.

In addition, since the dielectric layer is crystallized, the air pores in the dielectric layer can be reduced, and the withstanding voltage can be improved.

When the air pores are reduced, the mechanical strength of the panel can be improved.

Also, according to the PDP of the embodiments of the present invention, damage to the dielectric layer caused by a sand blasting process can be minimized. In addition, since the thermal expansion coefficient is lowered, the panel is resistant to thermal shock.

While the present invention has been particularly shown and described with reference to exemplary embodiments thereof, it will be understood by those of ordinary skill in the art that various modifications in form and details can be made therein without departing from the spirit and scope of the present invention as recited by the following claims.

1. A Plasma Display Panel (PDP) comprising:
a front substrate;
a sustain electrode arranged on the front substrate;
a front dielectric layer covering the sustain electrode;
a rear substrate facing the front substrate;
an address electrode arranged on the rear substrate;
a rear dielectric layer covering the address electrode, and having a crystallized structure;
barrier ribs disposed between the front and rear substrates; and
colored phosphor layers arranged in a discharge space defined by the barrier ribs.

2. The plasma display panel of claim 1, wherein the rear dielectric layer comprises a Li₂O—Al₂O₃—SiO₂ based layer.

3. The plasma display panel of claim 2, wherein the rear dielectric layer comprises SiO₂ of 5-75 wt %, Al₂O₃ of 14-30 wt %, and Li₂O of 1.5-3 wt %.

4. The plasma display panel of claim 2, wherein the rear dielectric layer comprises at least one nucleator selected from the group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂O₅ of 0-8 wt %.

5. The plasma display panel of claim 2, wherein the rear dielectric layer further comprises an alkaline earth metal.

6. The plasma display panel of claim 5, wherein the alkaline earth metal is within a range of 3-18 wt %.

7. The plasma display panel of claim 1, wherein the rear dielectric layer comprises a PbO—ZnO—Al₂O₃ based layer.

8. The plasma display panel of claim 7, wherein the rear dielectric layer comprises ZnO of 45 wt % or more, and Al₂O₃ of 14 wt % or more.

9. The plasma display panel of claim 7, wherein the rear dielectric layer comprises at least one nucleator selected from the group consisting of TiO₂ of 1-5 wt %, ZrO₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂O₅ of 0-8 wt %.

10. The plasma display panel of claim 7, wherein the rear dielectric layer further comprises an alkaline earth metal.

11. The plasma display panel of claim 10, wherein the alkaline earth metal is within a range of 3-18 wt %.

12. The plasma display panel of claim 1, wherein the rear dielectric layer comprises crystals having sizes in a range of 0.05-1.5 μm.

13. The plasma display panel of claim 1, wherein the rear dielectric layer is opaque to prevent emitted light from being transmitted therethrough.

14. A plasma display panel comprising:
a front substrate;
a sustain electrode arranged on the front substrate;
a rear substrate facing the front substrate;
an address electrode arranged on the rear substrate;
a dielectric layer covering at least one of the sustain electrode and the address electrode, and including a nucleator to diffusely reflect emitted light;
barrier ribs disposed between the front and rear substrates; and
colored phosphor layers arranged in a discharge area defined by the barrier ribs.

15. The plasma display panel of claim 14, wherein the dielectric layer comprises Li₂O—Al₂O₃—SiO₂.

16. The plasma display panel of claim 14, wherein the dielectric layer comprises PbO—ZnO—Al₂O₃.

17. The plasma display panel of claim 14, wherein the nucleator comprises at least one selected from the group consisting of TiO₂ of 1-5 wt %, Zro₂ of 0-4 wt %, TiO₂+ZrO₂ of 2-9 wt %, ZnO of 0-10 wt %, MgO of 0-2.5 wt %, CaO of 0-4 wt %, BaO of 0-6 wt %, B₂O₃ of 0-7 wt %, Na₂O of 0-4 wt %, and P₂O₅ of 0-8 wt %.

18. The plasma display panel of claim 14, wherein the dielectric layer further comprises an alkaline earth metal within a range of 3-18 wt %.

19. The plasma display panel of claim 14, wherein the dielectric layer comprises crystals having sizes in a range of 0.05-1.5 μm.
